(19) United States
(12) Patent Application Publication
(10) Pub. No.: US 2014/0210592 A1
(43) Pub. Date: Jul. 31, 2014

(54) APPARATUS AND METHOD FOR INTERFACING A WIRELESS COMMUNICATION DEVICE TO A COMMUNICATION DEVICE KEYPAD IN A VEHICLE

(71) Applicant: FORD GLOBAL TECHNOLOGIES, LLC, Dearborn, MI (US)

(72) Inventor: John Robert Van Wiemeersch, Novi, MI (US)

(73) Assignee: FORD GLOBAL TECHNOLOGIES, LLC, Dearborn, MI (US)

(21) Appl. No.: 13/750,288

(22) Filed: Jan. 25, 2013

(51) Int. Cl. G05B 1/01

(52) U.S. Cl. CPC G05B 1/01
USPC 340/5.61

(57) ABSTRACT

In at least one embodiment, an apparatus for interfacing a personal communication device (PCD) to a vehicle is provided. The apparatus comprises a vehicle module and a communication keypad device (CDK). The vehicle module is configured to detect a first signal indicative of an unlock command in connection with a passive entry operation to detect an access device. The CDK is positioned on the vehicle and is configured to determine whether the PCD has been positioned within a predetermined distance from the vehicle in the event the vehicle module is unable to detect the access device.

### TECHNICAL FIELD

Embodiments as disclosed herein generally relate to an apparatus and method for interfacing a portable wireless communication device to a communication device keypad (CDK) in a vehicle.

### BACKGROUND

It is generally known for a portable wireless device to be used in connection with a vehicle for unlocking or locking the vehicle.

One example of such an implementation is set forth in U.S. Publication No. 2010/0207722 (“the '722 publication”) to Rutledge et al. The '722 publication discloses a passive keyless entry system that comprises a wireless touch sensor and a one way radio frequency (RF) transmitter capable of transmitting an identification and proximity signal. The passive keyless entry system further comprises a system and a sensor antenna connected to the system that receives a touch sensor signal from the wireless touch sensor, and a RF transmitter antenna connected to the system that receives encoded identification and proximity signals from the RF transmitter. The system unlocks a locking mechanism when both the touch sensor signal and the RF transmitter signals are received and authorized by the system.

While the teachings as set forth in the '722 publication may be advantageous in certain implementations, there exists an opportunity for various embodiments as will be described herein to improve on the use of portable wireless devices that are used in connection with a vehicle for unlocking or locking the vehicle or performing other remote enable features.

### SUMMARY

In at least one embodiment, an apparatus for interfacing a personal communication device (PCD) to a vehicle is provided. The apparatus comprises a vehicle module and a communication keypad device (CDK). The vehicle module is configured to detect a first signal indicative of an unlock command in connection with a passive entry operation to detect an access device. The CDK is positioned on the vehicle and is configured to determine whether the PCD has been positioned within a predetermined distance from the vehicle in the event the vehicle module is unable to detect the access device.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompany drawings in which:

FIG. 1 depicts an apparatus for accessing a vehicle in accordance to one embodiment;

FIG. 2 depicts an apparatus for accessing the vehicle in accordance to another embodiment;

FIG. 3 depicts a user interface as provided on a personal communication device for remotely performing various function in relation to the vehicle in accordance to one embodiment; and

FIG. 4 depicts a method for accessing the vehicle in accordance to one embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ aspects of the present disclosure.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein.

In general, keypads are positioned on an exterior of a vehicle door and are used to gain access or to lock the vehicle in response to user entry of various predetermined numeric sequences as provided thereto. One possible keypad comprises a rubber pad including mechanical switches that are each electrically coupled to a controller for locking/unlocking the vehicle door (or liftgate/trunk, etc.). Another possible keypad comprises a capacitive-touch flush surface that includes switches, each being electrically coupled to a controller for locking/unlocking the vehicle door (or liftgate/trunk, etc.). Both the mechanic and capacitive switch implementations can be mounted on a B-pillar plastic trim on the vehicle. The capacitive switch implementation may be mounted on the B-pillar where various implementations may allow them to be virtually invisible under the plastic.

In some cases, convertible vehicles may not include a B-pillar for which to mount the capacitive keypad thereto. In addition, a hardtop vehicle may not have a plastic trim B-pillar to mount the keypad thereto. Likewise, vehicle styling or design considerations generally do not accept negative styling associated with rubber keypads on sheet metal of the vehicle. Such design considerations may require that trim generally included with the keypad be color coordinated with the respective color of the vehicle.

Various keypad implementations that may be explored in consideration of the foregoing may include: (i) the keypad being positioned in a door handle cup, (ii) the keypad being positioned on a door handle that is used in connection with a passive-entry passive start (PEPS) implementation, (iii) fixed glass keypads in which capacitive keypads are fixed to an inside surface of a glass (e.g., the switches can be read through the glass), and (iv) a moveable glass keypad in which switches are etched or linked into layers of a side window.

Various aspects of the present disclosure generally provide for a communication device keypad (CDK) that is configured to wirelessly interface with a portable communication device (PCD) (e.g., cell phone, etc.) for providing keypad related functionality without the use of various switches positioned thereon. This condition may enable, but not limited to, the CDK to consume less space from a vehicle packaging perspective and allow itself to be positioned anywhere within the vehicle where wireless communication with the PCD is not inhibited by distance or shielding from vehicle sheet metal and other metallic structures. In one example, the CDK may engage in near field communication (NFC) with the PCD and automatically unlock the vehicle when the PCD is positioned a predetermined distance from the CDK. In another example, the CDK and the portable communication device may engage in data transfer with one another using a Bluetooth ® protocol or other suitable communication network such that the CDK receives vehicle access commands from the portable communication device once security measures have been satisfied. In another example, the CDK may use NFC and/or Bluetooth to communicate with the PCD in the event a keyfob generally used in connection with the PEPS operation is not present or available. For example, in the event the PEPS operation is triggered via a door handle actuation or contact (e.g., driver touches door handle) and a portable keyfob is not found in connection with the PEPS operation, the CDK may then engage in communication with the PCD to unlock the vehicle if the portable communication device is positioned within a predetermined distance of the CDK. These and other aspects will be described in more detail below.

It is further recognized that various aspects of the present disclosure generally provide for the CDK that incorporates a capacitive switch implementation (e.g., capacitive button keypad). This CDK is wirelessly configured to interface with the PCD for providing keypad functionality with the use of various switches positioned thereon. In these aspects, the CDK will also engage in NFC with the PCD and automatically unlock the vehicle when the PCD is positioned a predetermined distance from the CDK. In another example, this CDK and the portable communication device may engage in data transfer with one another using a Bluetooth® protocol or other suitable communication network such that the CDK receives vehicle access commands from the portable communication device once security measures have been satisfied. In another example, the CDK may use NFC and/or Bluetooth to communicate with the PCD in the event a keyfob generally used in connection with the PEPS operation is not present or available. For example, in the event the PEPS operation is triggered via a door handle actuation or contact (e.g., driver touches door handle) and a portable keyfob is not found in connection with the PEPS operation, the CDK may then engage in communication with the PCD to unlock the vehicle if the portable communication device is positioned within a predetermined distance of the CDK. These and other aspects will be described in more detail below.

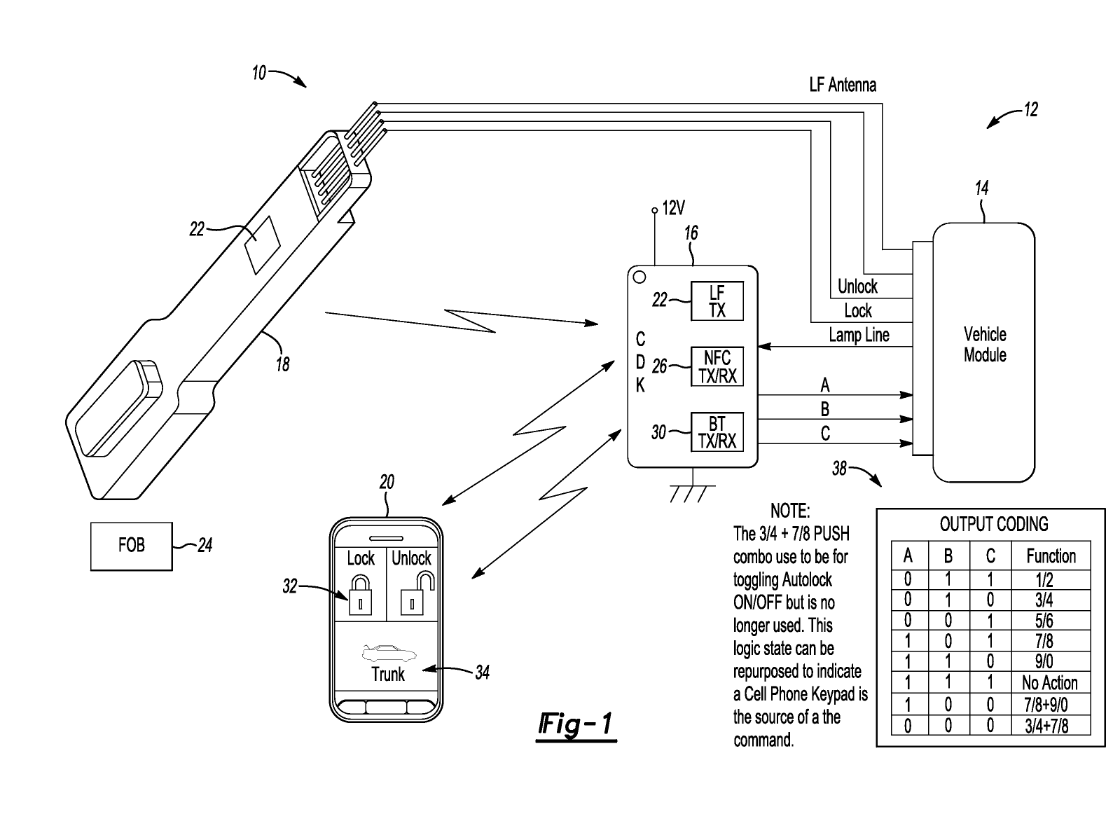

FIG. 1 depicts an apparatus 10 for accessing a vehicle 12 in accordance to one embodiment. The apparatus 10 comprises a vehicle module (“module”) 14, a CDK 16, a door handle sensor and initiator assembly (hereafter “door handle”) 18, and a portable communication device (PCD) 20. The module 14, the CDK 16, the door handle 18, and the PCD 20 may generally interact with one another to unlock the vehicle 12. The CDK 16 may be implemented with a thin profile that is free of any switches positioned thereon. This thin profile generally enables the CDK 16 to be positioned anywhere on the vehicle 12 where communication with the PCD 20 is still possible. In some cases, it may be desirable to ensure that the CDK 16 is not visible to meet styling requirements. In one example, the CDK 16 may be mounted on an interior side face of a door on the vehicle 12.

The door handle 18 generally includes a low frequency (LF) transmitter 22 for transmitting an LF signal (or other suitable frequency based signal) a keyfob 24 (e.g., access device) as part of a passive unlock operation. If the fob 24 is paired to the vehicle module 14, the fob 24 will respond to the LF challenge with an ultra high frequency (UHF) response that, if validated as proper, will allow the vehicle to unlock or recognize other fob commands. In one example, in the event a user is approaching the vehicle and desires to unlock the vehicle, the user may actuate an unlock sensor in the door handle electronics 18. An unlock sensor positioned within the door handle 18 is electrically coupled to the vehicle 12 and wakes-up the module 14. The module 14 commands the LF transmitter 22 in the door handle 18 to transmit a signal to the keyfob 24. The module 14, the LF transmitter 22, and the keyfob 24 may engage in a series of transmissions back and forth with one another (e.g., LF challenge and UHF response) to ensure the keyfob 24 is authorized to unlock the vehicle 12 via the passive unlock operation. It is recognized that the LF transmitter 22 may alternatively be positioned in the CDK 16 or anywhere else in the vehicle 12. In the event the door handle 18 is actuated (or contacted) (collectively referred to hereafter as actuated or actuation), and the LF transmitter 22 is unable to establish communication with the keyfob 24, then the CDK 16 will be activated in an attempt to establish wireless communication with the PCD 20. These aspects will be described in more detail below.

The CDK 16 is generally hardwire coupled to module 14. The CDK 16 also receives power from the power source of the vehicle 12. For example, a 12 volt power feed may be provided from the battery of the vehicle 12 to the CDK 16. The CDK 16 may include a NFC transceiver 26 for communicating with the PCD 20. For example, in the event the user actuates the door handle 18 and the LF challenge cannot be initiated or executed with the keyfob 24, then the module 14 activates a lamp line signal input to the CDK 16 to wake it up. The CDK 16 then activates the NFC transceiver 26 to determine if the PCD 20 is providing a NFC based signal (e.g., at a frequency of 13.56 MHz) to the CDK 16. If this condition is true, this represents that the user has placed the PCD 20 sufficiently proximate to the CDK 16 to establish communication. The CDK 16 may be positioned at a door seam mounted on the interior side face of the door on the vehicle 12. It is contemplated that other locations such as within a fuel door compartment or on a truck/lift-gate brow above a license plate, are also suitable locations for the CDK 16. In the event the CDK 16 detects the presence of the PCD 20 via NFC, then the CDK 16 may use communication lines A, B, and C to transmit an unlock signal to the module 14 to unlock the vehicle 12. With NFC, the PCD 20 is generally required to be within some predetermined distance of the CDK 16. The CDK 16 may be active for a predetermined amount of time to determine if the PCD 20 is placed thereabout for purposes of detecting the PCD 20 to unlock the vehicle 12. In one example, the CDK 16 may remain active after the door handle has been actuated for 5 seconds which may be the same amount of time a lamp on the CDK 16 is active to detect the presence of the PCD 20. In general, the module 14 may activate the CDK 16 for this 5 second period. Further, once the CDK 16 detects the PCD 20, the CDK 16 allows additional commands to be accepted from the PCD 20 for a predetermined period in the event a user intends to use the PCD 20 to open the trunk, lift-gate, etc.

The CDK 16 may also include a Bluetooth transceiver 30 for communicating with the PCD 20. The PCD 20 may also include a Bluetooth transceiver (not shown) for communicating with the vehicle 12. It is recognized that the Bluetooth transceiver may be located elsewhere in the vehicle such as in a hands-free cellular system. One example of the hands-free cellular system may be the Ford Sync® system. Prior to allowing communication between the PCD 20 and the vehicle 12 to unlock the vehicle, a security operation may be required (e.g., it is necessary to establish a secured connection between the PCD 20 and the vehicle 12). For example, if a user driver was allowed to unlock the vehicle 12 after detection of a door handle actuation with the PCD 20 via a signal transmitted over Bluetooth, such a feature may lack the desired security to unlock the vehicle since anyone may unlock the door after a door handle actuation if the PCD was within 10 to 30 meters of the vehicle. Thus, an unauthorized user may access the vehicle 12 parked on a driveway even though the PCD 20 may be safely within a home but still within range of the vehicle 12. To account for this condition, the apparatus 10 may require a security operation such as a valid NFC detection event to be performed prior to allowing the vehicle 12 to be unlocked via data transfer on the Bluetooth protocol. With the foregoing operation, security may be maintained by via the short range capability (e.g., two inches or other suitable range) of NFC while increased movement flexibility around the vehicle 12 may be provided in enabling data transfer via the Bluetooth protocol between the vehicle 12 and the PCD 20 for a predetermined amount of time after a valid NFC communication is established with the PCD 20.

Once a Bluetooth session is initiated after the security operation is performed, the PCD 20 may be arranged to provide vehicle access/security functions 32 on a display 34 thereof. Such vehicle access/security functions 32 may include, but not limited to, unlock, lock, trunk (or liftgate), remote start, etc. These operations are generally also selectable on the keyfob 24. However, the use of the PCD 20 provides an alternative to having to carry a separate keyfob 24 for purposes of gaining access to the vehicle 12 or for locking the vehicle 12. Since in most cases, the user will likely carry his/her PCD 20, this may obviate the need to carry the keyfob 24 to perform vehicle locking or unlocking.

It is recognized that the PCD 20 may either be NFC compatible, Bluetooth compatible, or Low Energy Bluetooth compatible. Generally, in the event the PCD 20 is a cell phone, it is believed that most cell phones are equipped to support Bluetooth communication. The PCD 20 may be equipped or fitted with an NFC option as well. However, in the event a particular CDK 16 is not provided with the NFC option, the CDK 16 may be continue to communicate with the vehicle 12 via the Bluetooth protocol to access the vehicle 12 while still performing a security operation to authenticate the user to the vehicle. For example, the PCD 20 may be configured to prompt the user to enter a code into the display 34 for the PCD 20 to then provide vehicle access/security functions 32 on the display 34 to enable the user to access the vehicle 12.

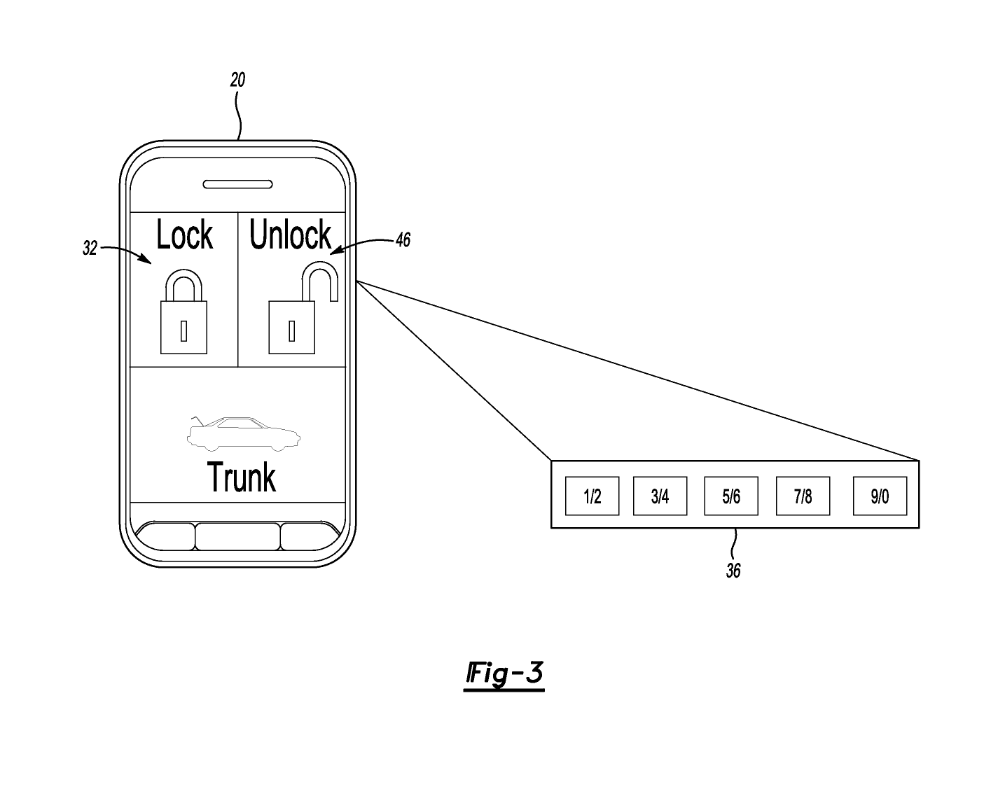

The vehicle access/security functions 32 may include various switches 36 (see FIG. 3) that are similar to those typically included on a keypad. These may be provided to increase security and to prevent unauthorized users who may have gained access to the PCD 20 from unlocking the vehicle 12. For example, the user may select or enter a predetermined sequence of characters via the switches 36 on the PCD 20 to unlock the vehicle 12. By placing the switches 36 on the PCD 20, such an arrangement enables the CDK 16 to be implemented without hardware based switches which enables the CDK 16 to encompass the low-profile implementation. As noted above, the low-profile implementation of the CDK 16 allows the CDK 16 to be implemented in any number of locations or positions in the vehicle 12.

The PCD 20 may wirelessly transmit data indicative of the predetermined sequence to the CDK 16. The CDK 16 may wirelessly receive such data and transmit the same to the module 14. The module 14, in turn, may receive the data in a manner similar to that shown in table 38 as depicted in FIG. 1. As shown in the table 38, corresponding values are provided with correspond to a particular switch 36. The corresponding outputs may be provided on lines A, B, and C as transmitted from the CDK 16 to the module 14. The user enters the proper or authorized sequence of characters into the PCD 16, such data is transmitted to the CDK 16 and to the module 14 which in turn unlocks the vehicle 12. It is recognized that the user may also control the module 14 to lock the vehicle 12 in the event the corresponding sequence of switches 36 are selected at the PCD 20. The module 14 may disable the CDK 16 via the lamp line input once wireless communication ceases between the CDK 16 and the module 14. In one example, the NFC session or Bluetooth session may time out in the event no activity is detected. The timeout period may be the same as that used for the timeout of the lamp line for the mechanical and/or capacitive keypads discussed above.

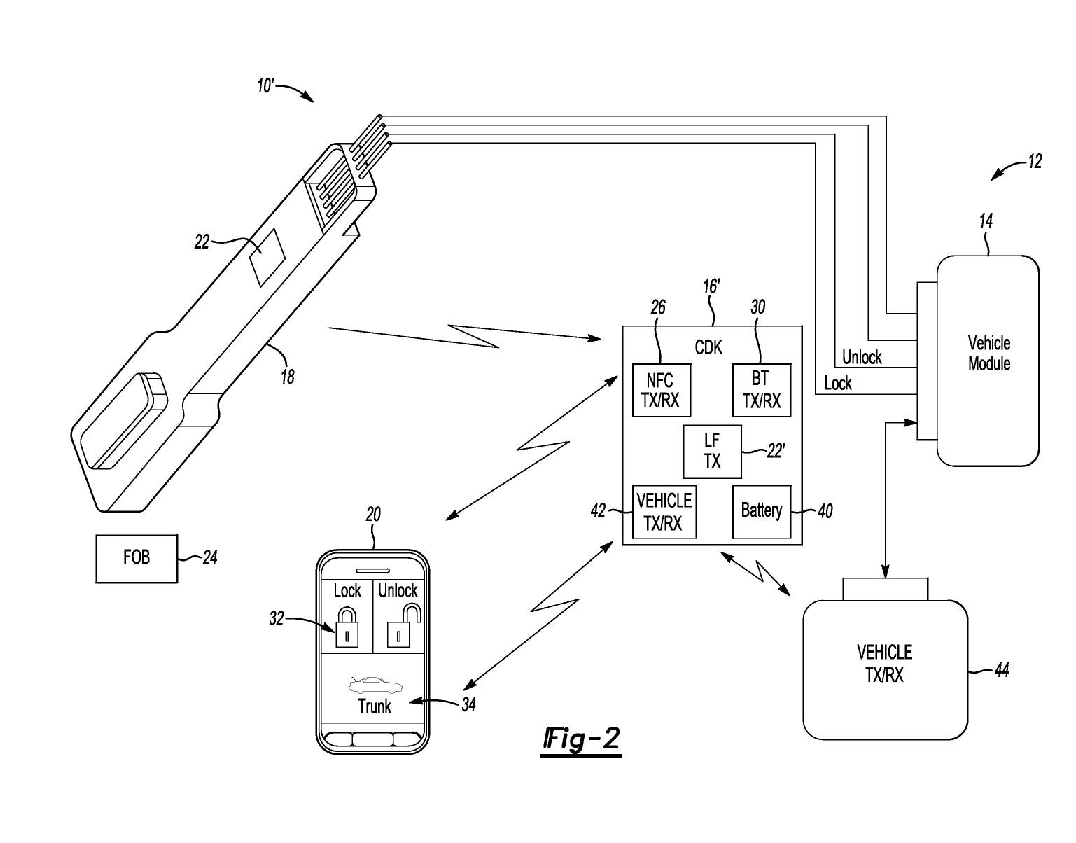

FIG. 2 depicts an apparatus 10′ for accessing the vehicle 12 in accordance to another embodiment. The apparatus 10′ is generally similar to the apparatus 10 as noted in connection to FIG. 1. However, the CDK 16′ is implemented in a different manner than the CDK 16 of FIG. 1. For example, the CDK 16′ includes a portable replaceable battery 40 for powering the CDK 16′. The battery 40 may also be a rechargeable battery with a charge collection circuit that harnesses energy from the LF transmitter 22 in the door handle assembly 18. The CDK 16′ further includes a first vehicle transceiver 42 for wirelessly communicating with a second vehicle transceiver 44. The second vehicle transceiver 44 may wirelessly receive data from the CDK 16′ and provide the received data to the module 14 or to any other module that is situated to control the locking and unlocking features of the vehicle 12 (this may also apply to the apparatus 10 of FIG. 1 as the UHF receiver may be in the CDK 16 or within the module 14). In one example, the CDK 16′ may include an adhesive backing for being coupled to any number of locations in the vehicle 12. In another example, the CDK 16′ may include mounting eyelets to allow the CDK 16′ to be fastened to a vehicle surface.

This wireless characteristic of the CDK 16′ further enables the CDK 16′ to be packaged in any number of locations within the vehicle 12. For example, with the wireless implementation, it is not necessary to run wiring from the module 14 to the CDK 16′. This option eliminates the need for connector headers to be positioned on the CDK 16′ and further reduces the overall size or package of the CDK 16′. In general, the CDK 16′ is arranged to transmit and receive data and operate in a similar manner with respect to the module 14, the door handle 18, and the PCD 20, as noted in connection with the apparatus 10 of FIG. 1.

FIG. 3 depicts a user interface 46 as provided on the PCD 20 for remotely performing various functions in relation to the vehicle 12 in accordance to one embodiment. As shown in one example, the user interface 46 provides the vehicle access/security functions 32 and/or the switches 36, which may be selected by the user to perform one or more of the following vehicle operations: lock all when the vehicle 12 is off, lock all when the vehicle 12 is running, unlock driver's door, unlock all doors, release a decklid, activate/deactivate auto-unlock, program unique codes, panic, toggle between 1-step and 2-step unlock, remote start, etc.

While the CDK 16 and/or 16′ as disclosed above may be implemented without the use of hardware switches, the present disclosure contemplates that the CDK 16 and 16′ may be implemented with a capacitive switch implementation (e.g., capacitive button keypad) (i.e., hardware switches positioned thereon) (hereafter CDK 16″). In this case, the NFC transceiver 26 may be positioned about a general periphery of the CDK 16″, around a specific key (or switch), or at a top or bottom of the CDK 16″. The NFC transceiver 26 may also be positioned around the periphery of one switch, or at a zone at the top or bottom thereof. In general, the switch or key at which the NFC transceiver 26 is generally disposed about may be configured to illuminate when the CDK 16″ is powered to identify the location of the NFC transceiver 26 for placement of the PCD 20. In general, the CDK 16″ is generally configured to function similarly to CDK 16 and 16′ as noted above in terms of interfacing with the passive unlock operation via the door handle 18 and the operations noted in connection with NFC and Bluetooth communications (i.e., interfacing with the PCD 20).

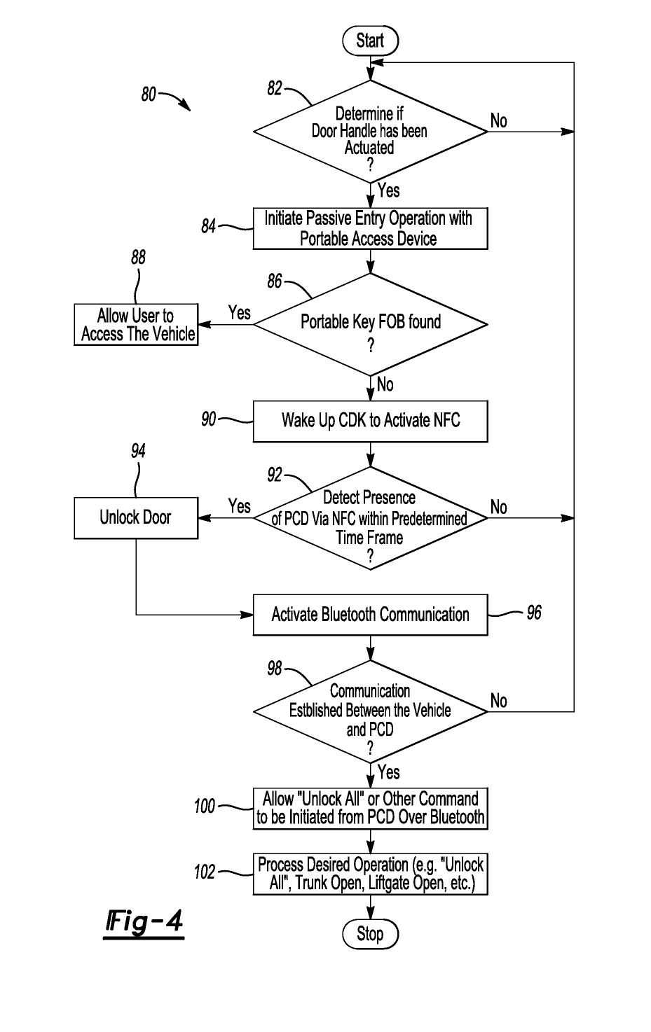

FIG. 4 depicts a method 80 for accessing the vehicle 12 in accordance to one embodiment.

In operation 82, the module 14 determines whether the user has actuated the door handle 18. If the door handle 18 has not been actuated, then the method 80 remains in operation 82. If so, then the method 80 moves to operation 84. Actuation of the door handle 18 may be indicative of the user desiring to gain access to the vehicle. Accordingly, the door handle 18 may generate an unlock command and transmit the same to the module 14 when actuated.

In operation 84, the module 14 controls the LF transmitter 22 to transmit the LF signal to the keyfob 24 to initiate a challenge sequence for determining whether the keyfob 24 is authorized to unlock the vehicle 12 in the event it is located a predetermined distance from the vehicle 12.

In operation 86, the module 14 determines whether the keyfob 24 has successfully performed a challenge sequence with the vehicle 12. If the module 14 determines that the keyfob 24 was found and responded successfully to the challenge, then the method moves to operation 88. If not, then the method 80 moves to operation 90.

In operation 88, the module 14 unlocks the vehicle 12 for the user.

In operation 90, the module 14 wakes up the CDK 16 to activate the NFC transceiver 26.

In operation 92, the module 14 determines whether the user has placed his/her PCD 20 proximate to the CDK 16 within the predetermined amount of time to perform the security operation via NFC. In the event the PCD 20 is positioned proximate to the CDK 16 within the predetermined amount of time, the CDK 16 then transmits an unlock signal to the module 14. The module 14 will determine whether the PCD 20 has been placed proximate to the CDK 16 (or within a predetermined distance from the CDK 16 (e.g., two to three inches or other suitable distance) based on the receipt of the unlock signal from the CDK 16 within the predetermined amount of time. If this condition is met, then the method 80 moves to operation 94. If not, then the method 80 moves back to operation 82. Also, in the event the module 14 is unable to determine whether the user has placed his/her PCD 20 proximate to the CDK 16 within the predetermined amount of time, then method 80 moves back to operation 82.

In operation 94, the module 14 unlocks the vehicle for the user.

Upon a successful unlocking operation, the method 80 moves to operation 96. In operation 96, the module 14 controls the CDK 16 to activate the Bluetooth transceiver 30 if located in the CDK 16. As noted above, the Bluetooth transceiver 30 may be positioned in a hands-free cellular talk system or other suitable device within the vehicle 12. Once a valid operation 94 occurs thus validating the PCD 20 is securely within range of the vehicle 12, then it permissible to allow Bluetooth communications for the purpose of allowing the user more freedom of movement than NFC allows in the vicinity of the vehicle 12 if the user chooses to command additional vehicle features from the display 34 of PCD 20 for a short predetermined period.

In operation 98, the module 14 determines whether the CDK 16 has established communication with the PCD 20 via Bluetooth. If this condition is not true, then the method 80 moves back to operation 82. If this condition is true, then the method 80 moves to operation 100.

In operation 100, the module 14 processes commands as received from the PCD 20 via the CDK 16 to perform other unlock operations (such as all unlock, trunk, lift-gate, etc.). As noted above, the PCD 20 may then allow the user to select other unlock operations (all unlock, trunk, lift-gate, etc.) as provided via the vehicle access/security functions 32 on the user interface 46. For example, the user may select the “all unlock” function 32 on the PCD 20 to command the module 14 to perform the all unlock operation.

As noted above, in the event the PCD 20 is not NFC enabled, then the user may enter a predetermined sequence via the switches 36 which resemble a keypad entry to unlock the vehicle 12. Such data may be transmitted via Bluetooth to the vehicle 12. The module 14 may receive the entered data from the PCD 20 via the CDK 16 and determine whether such data corresponds to the predetermined sequence which enables the vehicle 12 to respond to the Bluetooth transmitted commands (i.e., unlock, all unlock, trunk open, lift-gate open, etc.).

In operation 102, the module 14 performs the desired operation as indicated in operation 100.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An apparatus for interfacing a personal communication device (PCD) to a vehicle, the apparatus comprising:
a vehicle module configured to detect a first signal indicative of an unlock command in connection with a passive entry operation to detect an access device; and
a communication keypad device (CDK) for being positioned on the vehicle and for determining whether a portable communication device (PCD) has been positioned within a predetermined distance from the vehicle in the event the vehicle module is unable to detect the access device.

2. The apparatus of claim 1 wherein the CDK includes a first receiver for wirelessly receiving a second signal from the PCD to determine if the PCD has been positioned within the predetermined distance of the vehicle.

3. The apparatus of claim 2 wherein the first receiver is a near field communication (NFC) transceiver.

4. The apparatus of claim 3 wherein the CDK is configured to determine that the PCD is within the predetermined distance from the vehicle in response to the NFC receiver receiving a second signal from the PCD to establish a secured connection with the PCD.

5. The apparatus of claim 4 wherein the vehicle is configured to receive a control signal indicative of any one of a lock all operation, an unlock all doors, a release a decklid in the vehicle, power open/close a liftgate, activate/deactivate an auto-unlock operation, a programming of unique codes, a panic alarm operation, a toggle between a one step and two-step unlock operation, and a remote start operation from the PCD in response to the PCD being within the predetermined distance from the vehicle.

6. The apparatus of claim 5 wherein the control signal is a Bluetooth based signal.

7. The apparatus of claim 1 wherein the access device is a keyfob.

8. The apparatus of claim 1 wherein the PCD includes a display for receiving a predetermined code from a user to perform any one of lock all command, unlock all doors, release a decklid in the vehicle, power open/close a liftgate, activate/deactivate auto-unlock, program unique codes, panic, toggle between one step and two-step unlock, and remote start.

9. The apparatus of claim 1 wherein the vehicle module is configured to detect the first signal in response to a door handle contact or actuation.

10. The apparatus of claim 1 wherein the CDK is not visible to a user.

11. The apparatus of claim 1 wherein the CDK is positioned on one of a side face on a door, a seam of the door in the vehicle, a fuel door compartment, and on a truck/lift-gate brow above a license plate.

12. A method for interfacing a personal communication device (PCD) to a vehicle, the method comprising:
detecting a first signal indicative of an unlock command in connection with a passive entry operation to detect an access device; and
determining, with a communication keypad device (CDK), whether the PCD has been positioned within a predetermined distance from the vehicle in the event the access device is not detected.

13. The method of 12 further comprising wirelessly receiving, at the CDK, a second signal from the from the PCD to determine if the PCD has been positioned within the predetermined distance of the vehicle.

14. The method of claim 13 wherein wirelessly receiving at the CDK further comprises wirelessly receiving, at a near field communication (NFC) receiver, the second signal from the PCD to determine if the PCD has been positioned within the predetermine distance of the vehicle to establish a secured connection between the vehicle and the PCD.

15. The method of claim 14 further comprising determining that the PCD is within the predetermined distance from the vehicle in response to the NFC transceiver receiving the second signal from the PCD.

16. The method of claim 14 further comprising receiving a control signal indicative of any one of a lock all operation, an unlock all doors, a release a decklid in the vehicle, power open/close a liftgate, an activate/deactivate an auto-unlock operation, programming of unique codes, a panic operation, a toggle between a one step and two-step unlock operation, and a remote start operation from the PCD in response to the PCD being within the predetermined distance from the vehicle.

17. The method of claim 16 wherein the control signal is a Bluetooth based signal.

18. The method of claim 12 wherein the access device is a keyfob.

19. The method of claim 12 wherein detecting the first signal further comprises detecting the first signal in response to a door handle contact or actuation.

20. A vehicle apparatus comprising:
a vehicle module configured to detect a signal indicative of an unlock command in connection with a door handle contact or actuation to detect an access device; and
a communication keypad device (CDK) and for determining whether a portable communication device (PCD) has been positioned within a predetermined distance from the vehicle via near field communication (NFC) in the event the vehicle module is unable to detect the access device.
